(19) United States
(12) Patent Application Publication
(10) Pub. No.: US 2002/0174879 A1
(43) Pub. Date: Nov. 28, 2002

(54) Method for cleaning a semiconductor wafer

(76) Inventor: Chung-Tai Chen, Hsinchu Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/063,469

(22) Filed: Apr. 26, 2002

(30) Foreign Application Priority Data
Apr. 30, 2001 (TW) 90110254

(51) Int. Cl. B08B 3/08

(52) U.S. Cl. 134/3; 134/26; 134/28; 134/36

(57) ABSTRACT

A semiconductor wafer cleaning method is provided. A wafer is provided. The wafer is cleaned with a chemical cleaning solution, wherein the concentration of the chemical cleaning solution decreases as the cleaning time progresses. The wafer is then cleaned with deionized water to remove the chemical cleaning solution that is remained on the wafer surface.

### CROSS REFERENCE TO RELATED APPLICATIONS

This application claims the priority benefit of Taiwan application serial no. 90110254, filed Apr. 30, 2001.

### BACKGROUND OF INVENTION

1. Field of Invention

This invention relates to a cleaning method for a semiconductor device. More particularly, the present invention relates to a method for cleaning a semiconductor wafer.

2. Description of Related Art

In the fabrication process of integrated-circuit devices, wafer cleaning is the most frequent performed processing step. The purpose of wafer cleaning is to remove the organic compound, the metal crud or particulate that is attached to the surface of the wafer. These contaminants greatly affect the subsequent process and the quality of the product. The metal crud contaminant would lead to a current leakage at the p-n junction, a reduction of the lifetime of some carriers and a reduction of the breakdown voltage of the gate oxide layer. The attachment of particulate to the surface of a wafer would definitely affect the accuracy of pattern transferring in a photolithography process. It may even lead to a short circuit. The wafer cleaning process, therefore, must be able to effectively remove the organic compound, the metal crud and particulate. Moreover, a formation of a native oxide layer on the wafer surface after the cleaning process has to be prevented to minimize the surface roughness.

In order to remove the organic compound, metal crud or particulate attached to the wafer surface, the wafer is cleaned with a chemical cleaning solution that contains either an acid or a basic reagent. The most commonly employed wafer cleaning process in the current industry is the RCA cleaning process. In the RCA wafer cleaning process, the wafer is cleaned using a SC1 cleaning solution (NH₄OH/H₂O₂/H₂O=1:1:5), also known as APM, at a temperature of 75 degrees Celsius to 85 degrees Celsius to remove the organic compound and particulate that is attached to the wafer surface. Thereafter, a quick-dump rinse (QDR) process is conducted using a large quantity of deionized water to clean the wafer surface and to remove the SC1 cleaning solution remaining on the wafer surface. A SC2 cleaning process is further performed using the SC2 cleaning solution (NH₄OH/H₂O₂/H₂O=1:1:6), also known as HPM, at a temperature of 75 degrees Celsius to 85 degrees Celsius to remove the metal crud that is attached to the wafer surface. A quick-dump rinse (QDR) process is again conducted, using a large quantity of deionized water to clean the wafer surface and to remove the SC2 cleaning solution remaining on the wafer surface.

In the above RCA process, a fixed concentration of the chemical cleaning solution (the SCI cleaning solution or the SC2 cleaning solution) is used to clean the wafer. The concentration of the chemical cleaning solution (either the SC1 cleaning solution or the SC2 cleaning solution) that is remained on the wafer surface is very high. Therefore, a huge quantity of deionized water is needed in the subsequent quick-dump rinse process to completely remove the cleaning solution residue that is remained on the wafer surface.

### SUMMARY OF INVENTION

The present invention provides a semiconductor wafer cleaning method, wherein the concentration of the chemical cleaning solution changes from high to low as the cleaning time progresses. The concentration of the chemical cleaning solution remaining on the wafer surface decreases to a minimum before the quick-dump rinse process. The amount of deionized water used in the quick-dump rinse process thereby reduced. As a result, the manufacturing cost is reduced and the efficiency of the manufacturing process is increased.

The present invention provides a semiconductor wafer cleaning method, wherein the concentration of the chemical cleaning solution decreases significantly as the cleaning time progresses. The quantity of the chemical reagent in the chemical cleaning solution can thus reduce to lower the manufacturing cost and to increase the efficiency of the process.

The present invention provides a cleaning method for a semiconductor wafer, wherein a wafer is provided. A chemical cleaning solution is used to clean the wafer, wherein the concentration of the chemical solution decreases as the cleaning time progresses. Deionized water is further used to clean the wafer to remove the chemical cleaning solution residue on the wafer surface.

The invention provides a wafer cleaning method, wherein during the wafer cleaning with a chemical cleaning solution, the concentration of the chemical cleaning solution is controlled so that the concentration of the chemical cleaning solution changes as a function of the cleaning time. As a result, the concentration of the chemical cleaning solution remaining on the wafer surface decreases to a minimum before the quick dump rinse process. The amount of deionized water used in the quick dump rinse process is thus reduced. Moreover, the amount of the regent used the chemical cleaning process is also reduced.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow diagram, illustrating the successive steps of a semiconductor wafer cleaning method according to a preferred embodiment of the present invention.

### DETAILED DESCRIPTION

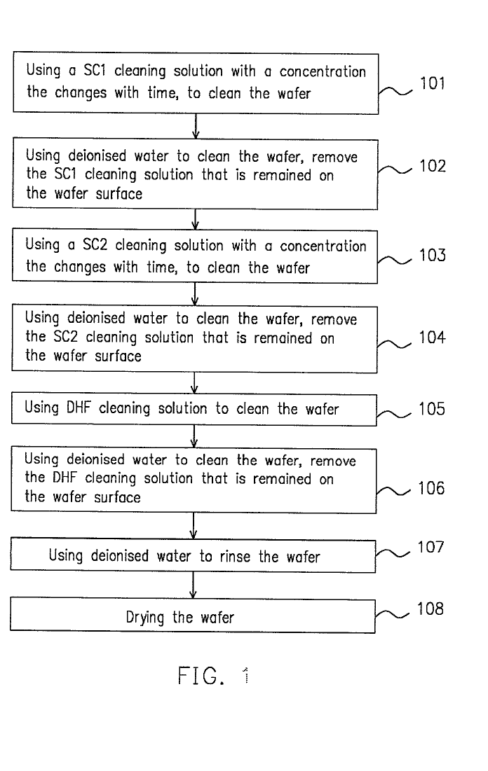

Referring to FIG. 1, FIG. 1 is a flow diagram, illustrating the successive steps of a semiconductor wafer cleaning method according to a preferred embodiment of the present invention.

Step 101: Using a basic chemical cleaning solution that comprises a basic reagent to remove the organic compound and particulate that are attached to the surface of the wafer. The basic chemical cleaning solution, for example, a SC1 solution, is an aqueous solution of an ammonium/hydrogen peroxide/deionized water mixture.

A wafer to be cleaned is provided. The wafer is placed on a cleaning apparatus. The cleaning apparatus is, for example, the spraying type with a single chemical cleaning tank or a cleaning tank that comprises an apparatus to control the concentration of the cleaning solution. The SCI cleaning solution is then delivered to the cleaning apparatus to clean the wafer. The SCI cleaning solution is, for example, a mixture of ammonium, hydrogen peroxide and deionized water. The SC1 cleaning is conducted at a temperature of about 75 degrees Celsius to 85 degrees Celsius. Moreover, the ammonium in the SCI cleaning solution may serve as a surface active agent to hydrolyze the organic crud by changing the potential energy or the zeta potential of the wafer surface. Hydrogen peroxide may also serve as an oxidizer to oxidize the organic crud.

During the SC1 cleaning process, the concentration of the SC1 cleaning solution changes as the cleaning time progresses. The cleaning time for the SCI cleaning process is separated into M time periods, wherein M is a whole number greater than The concentration of the chemical cleaning solution of the N^{th} time period is lower the concentration of the chemical cleaning solution of the N-1^{th} time period, wherein N is a whole number less than M and greater than 1. For example, the cleaning time for a SCI cleaning process is about 5 minutes (300 seconds), the cleaning time is then divided into 5 time periods (M=5), and each time period is about 60 seconds. The weight ratio of the components in the SC1 cleaning solution changes according to each time period. As the cleaning time progresses, the ratio of deionized water to ammonium in the SCI cleaning solution gradually increases. In another words, the ammonium in the SC1 cleaning solution decreases as the cleaning time progresses. As shown in Table 1, at the beginning of the cleaning process (Time period 1), the weight ratio of NH₄OH/H₂O₂/H₂O in the SC1 cleaning solution is 1:1:5. The concentration of ammonium in the SC1 cleaning solution in Time period 1 is about 14.2% by weight. The weight ratio of NH₄OH/H₂O₂/H₂O in Time period 2 changes to 1:1:10, and the concentration of ammonium in the SC1 cleaning solution decreases to 8.3%. As the SC1 cleaning process continues to Time period 5, the concentration of ammonium in the SC1 cleaning solution is only 3.7% by weight. Since the concentration of ammonium in the SC1 cleaning solution decreases as the cleaning time progresses, the concentration of the SC1 cleaning solution remaining on the wafer surface reduces to a minimum at the completion of the SC1 cleaning process.

TABLE 1

| | | | Weight Ratio of | |
|---|---|---|---|---|
| | | | NH₄OH/H₂O₂/ | NH₄OH |
| | | Cleaning | H₂O in SC1 | Concentration |
| Time Period | | Duration | Cleaning Solution | (%) |
| (1) | 0-60 seconds | 60 seconds | 1:1:5 | 14.2% |
| (2) | 60-20 seconds | 60 seconds | 1:1:10 | 8.3% |
| (3) | 120-180 seconds | 60 seconds | 1:1:15 | 5.9% |
| (4) | 180-240 seconds | 60 seconds | 1:1:20 | 4.5% |
| (5) | 240-300 seconds | 60 seconds | 1:1:25 | 3.7% |

Step 102: A quick-dump rinse (QDR) process, using a large quantity of deionized water to clean the wafer surface and to remove the SC1 cleaning solution residue on the wafer surface, is performed. Since at the completion of the SC1 cleaning process (step 101), the concentration of the SC1 cleaning solution residue decreases to a minimum, the amount of deionized water used in step 102 can be reduced.

Step 103: An acid chemical solution, which comprises an acid reagent, is used to clean the wafer by removing the metal particulate that is attached to the surface of the wafer. The acid cleaning solution is, for example, a SC2 cleaning solution, which is an aqueous solution of a hydrochloric acid/hydrogen peroxide/deionized water mixture. The temperature for the SC2 cleaning process is about 75 degrees Celsius to about 85 degrees Celsius. The hydrochloric acid reacts with the metal particulate, which is thereby removed as metal ions dissolved in the chemical cleaning solution.

During the SC2 cleaning process, the concentration of the SC2 cleaning solution changes as the cleaning time progresses. The way the concentration of the SC2 cleaning solution changes as the cleaning time progresses is similar to that of the SC1 cleaning solution as described in step 101. The cleaning time is divided into several time periods, wherein the weight ratio of the components in the SC2 cleaning solution changes according to each time period. As the cleaning time increases, the ratio of deionized water to hydrochloric acid in the SC2 cleaning solution gradually increases. The concentration of hydrochloric acid in the SC2 cleaning solution thus reduces to a minimum as time progresses.

Since the concentration of hydrochloric acid in the SC2 cleaning solution decreases as the cleaning time progresses, the SC2 cleaning solution residue remaining on the wafer surface reaches a minimum value at the completion of the SC2 cleaning process.

Step 104: A quick-dump rinse (QDR) process, using a large quantity of deionized water to clean the wafer surface and to remove the SC2 cleaning solution residue on the wafer surface, is performed. Since at the completion of the SC2 cleaning process, the concentration of the SC2 cleaning solution residue decreases to the minimum, the amount of deionized water used can be reduced.

Step 105: A dilute hydrofluoric acid (DHF) cleaning process is performed by placing the wafer in a dilute hydrofluoric acid aqueous solution (HF/H₂O=1:99) to remove the native oxide layer on the wafer.

Step 106: A quick-dump rinse (QDR) process is performed by using a large quantity of deionized water to clean the wafer surface and to remove the DHF cleaning solution remaining on the surface of the wafer.

Step 107: A rinsing process is performed by placing the wafer into the final rinse (FR) tank. Further combining with an ultrasound vibration, the wafer is cleaned.

Step 108: A drying process is performed by placing the wafer in a drying unit, for example, in an isopropyl alcohol (IPA) unit using the IPA vapor to remove the moisture on the wafer and to dry wafer.

The present invention provides a cleaning method for a semiconductor wafer, wherein before the quick-dump rinse process, the concentration of the chemical cleaning solution is controlled such that the concentration of the acidicreagent or the basic reagent is reduced to a minimum to reduce the quantity of deionized water used in the quick-dump rinse process, the amount of the acid or the basic reagent and the cleaning time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for cleaning a semiconductor wafer, comprising:
providing a wafer;
placing the wafer in a cleaning tank;
providing a cleaning solution into the cleaning tank to clean the wafer, wherein a concentration of the cleaning solution reduces as a cleaning time progresses; and
using deionized water to remove the chemical cleaning solution that is remained on a surface of the wafer.

2. The method of claim 1, wherein reducing the concentration of the chemical cleaning solution as the cleaning time progresses includes:
dividing a cleaning time for a chemical cleaning process into M time periods, wherein M is a whole number greater than 1; and
lowering the concentration of the chemical cleaning solution at an N^{th} time period from the concentration of the chemical cleaning solution at an N-1^{th} time period, wherein N is a whole number less than M and greater than 1.

3. The method of claim 2, wherein the chemical cleaning solution comprises at least a surface active agent.

4. The method of claim 3, wherein the surface active agent includes ammonium.

5. The method of claim 1, the chemical cleaning solution comprises at least an oxidizer.

6. The method of claim 5, wherein the oxidizer is selected from the group consisting of hydrogen peroxide and hydrochloric acid.

7. The method of claim 1, wherein the chemical cleaning solution includes an aqueous solution of an ammonium/hydrogen peroxide/deionized water mixture.

8. The method of claim 1, wherein the chemical cleaning solution includes an aqueous solution of a hydrochloric acid/hydrogen peroxide/deionized water mixture.

9. A semiconductor wafer cleaning method, comprising:
providing a wafer;
using a chemical cleaning solution that comprises at least a chemical reagent, wherein a concentration of the chemical reagent in the chemical cleaning solution decreases as a cleaning time progresses; and
cleaning the wafer with deionized water to remove the chemical cleaning solution that is remained on a surface of the wafer.

10. The method of claim 9, wherein the chemical reagent is selected from the group consisting of an acid reagent, a basic reagent and an oxidizer.

11. The method of claim 9, wherein the acid reagent includes hydrochloric acid.

12. The method of claim 10, wherein the basic reagent includes ammonium.

13. The method of claim 10, wherein the oxidizer includes hydrogen peroxide.

14. The method of claim 9, wherein decreasing the concentration of the chemical cleaning solution as the cleaning time progresses includes:
dividing a cleaning time for a chemical cleaning process into several time periods; and
increasing a weight ratio of deionized water to the chemical reagent in the chemical cleaning solution as the time period increases.

15. A semiconductor wafer cleaning method, comprising:
providing a wafer;
using a first cleaning solution to clean the wafer by removing an organic compound or particulate that is attached to a surface of the wafer, wherein a concentration of the first cleaning solution decreases as a cleaning time progresses;
using deionized water to clean the wafer by removing the first cleaning solution that is remained on the surface of the wafer;
using a second cleaning solution to clean the wafer by removing an metal particulate that is attached to the surface of the wafer, wherein a concentration of the second cleaning solution decreases as the cleaning time progresses; and
using deionized water to clean the wafer by removing the second cleaning solution that is remained on the surface of the wafer.

16. The method of claim 15, wherein the first cleaning solution includes an aqueous solution an ammonium/hydrogen peroxide/deionized water mixture.

17. The method of claim 16, wherein decreasing the concentration of the first chemical cleaning solution as the cleaning time progresses includes:
dividing the cleaning time for a first chemical cleaning process into several time periods; and
increasing a weight ratio of deionized water to ammonium in the first chemical cleaning solution as the time period increases.

18. The method of claim 15, wherein the second cleaning solution includes an aqueous solution of a hydrochloric acid/hydrogen peroxide/deionized water mixture.

19. The method of claim 16, wherein reducing the concentration of the second chemical cleaning solution as the cleaning time progresses includes:
dividing the cleaning time for a second chemical cleaning process into several time periods; and
increasing a weight ratio of deionized water to hydrochloric acid in the second chemical cleaning solution as the time period increases.
